(19) United States
(12) Patent Application Publication
(10) Pub. No.: US 2007/0017969 A1
(43) Pub. Date: Jan. 25, 2007

(54) Identification card

(76) Inventor: James B. Wilson III, Cleveland, OH (US)

Correspondence Address: SQUIRE, SANDERS & DEMPSEY L.L.P., 1 MARITIME PLAZA, SUITE 300, SAN FRANCISCO, CA, 94111, US

(21) Appl. No.: 11/486,457

(22) Filed: Jul. 14, 2006

Related U.S. Application Data
(60) Provisional application No. 60/699,562, filed on Jul. 14, 2005.

(51) Int. Cl. G06F 17/00; G06F 12/00

(52) U.S. Cl. 235/375; 711/115

(57) ABSTRACT

An identification card includes a card portion and a USB flash drive that is pivotably attached to the card portion.

### FIELD OF THE INVENTION

This invention relates to an identification card.

### BACKGROUND OF THE INVENTION

A smart card is a plastic card that is embedded with integrated circuits. There are generally two types of smart cards: (1) memory cards that contain memory storage integrated circuits and (2) microprocessor cards that contain integrated circuits for both memory storage and a microprocessor.

A smart card is used to store and process data, and a card reader is required to transfer data to and from a smart card. A smart card can be a contact card, which must be inserted into a reader and requires physical contact for data transfer. A smart card can also be a contactless card, which is powered by a Radio Frequency signal and does not require physical contact with a reader for data transfer.

One limitation on the use of smart cards is the relatively limited availability of card readers. Without a card reader, data cannot be transferred from or to a smart card.

### SUMMARY OF THE INVENTION

The present invention can overcome the above-discussed limitation of smart cards. In the present invention, an identification card includes a card portion and a USB flash drive that is attached to the card portion, wherein data may be stored in the USB flash drive.

The use of a USB flash drive as the memory storage and/or the microprocessor for an identification card has numerous advantages. For example, the wide accessibility of USB ports, especially on modern computers, means that an identification card of the present invention can be used almost anywhere. For another example, compared with a conventional smart card, an identification card of the present invention is much more resistance to wear, scratches and bending.

### BRIEF DESCRIPTION OF THE DRAWINGS

FIG. 1 is a front view of an identification card of the present invention with the USB flash drive in the closed position.

FIG. 2 is a back view of the identification card of FIG. 1.

FIG. 3 is a front view of the identification card of FIG. 1 with the USB flash drive in an open position.

### DETAILED DESCRIPTION OF PREFERRED EMBODIMENTS

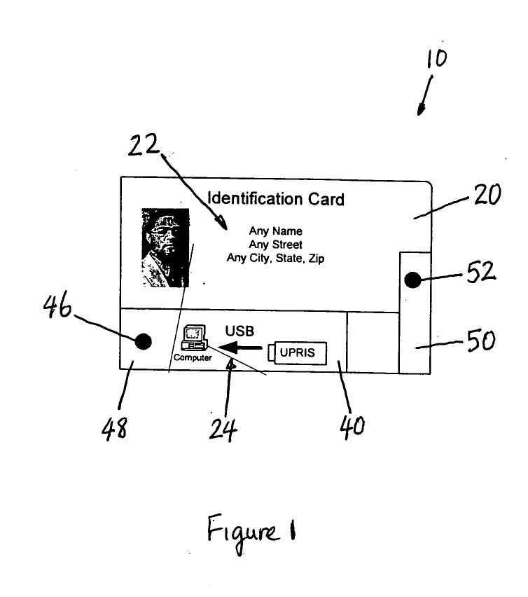

FIG. 1 is a front view of an identification card 10 of the present invention. The identification card 10 includes a card portion 20 and a USB flash drive 40 that is attached to the card portion 20.

The card portion 20 preferably has a generally flat and rectangular configuration, such as the configuration of a credit card, although it may have any suitable configuration. The card portion 20 can be dimensioned based on any one of the standard formats. For example, the card portion 20 can adopt any of the formats of ISO 7810, such as the ID-1format. In general, however, the card portion 20 may have any suitable dimensions.

Preferably, the card portion 20 is made from a plastic material, although it can be made from any suitable material, such as a metallic material.

The card portion 20 may contain various printed information that may be useful to the user and can help in the recovery of a lost card. The information may include, for example, information about the user of the card, such as the user's name, address, telephone number, social security number, emergency contact information, nationality, gender, weight, age, hair color, eye color, height, and photograph. The printed information may also include information about the issuer of the identification card 10, such as the issuer's name, address, customer service telephone number, website, facsimile number, and email address. The printed information may additionally include information on how to use the card. The printed information may further include the specifications for the USB flash drive 40.

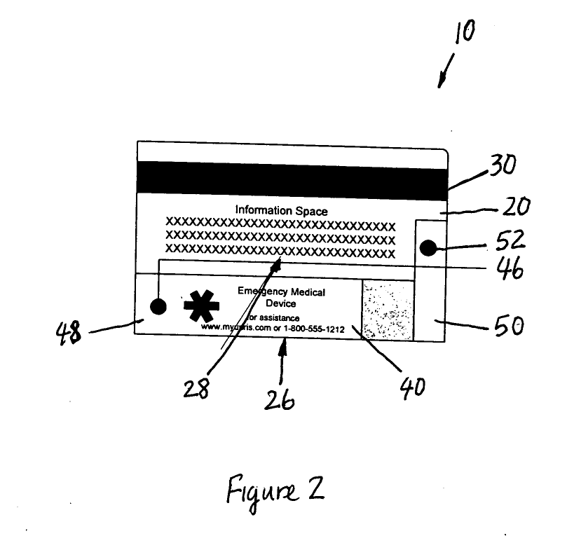

In the illustrated embodiment, the card portion 20 includes user information 22 on the front side (FIG. 1), instructions for the user 24 on the front side (FIG. 1), emergency information 26 on the back (FIG. 2), and an information space 28 (FIG. 2).

The card portion 20 may include a magnetic strip 30 used to magnetically store information.

In one embodiment of the present invention, the card portion 20 uses the ISO 7811 format for the printed information and magnetic strip. Since the format is well known, it will not be described herein in detail.

The USB flash drive 40 may have any suitable dimensions and capacity. Preferably, the USB flash drive 40 has a generally elongated, parallelepiped configuration with its length and width much greater than its thickness. The USB flash drive 40 may have any suitable memory size, such as 2 MB, 4 MB, 8 MB, 16 MB, 32MB or 64 MB. Flash drive is well known and will not be described herein in detail.

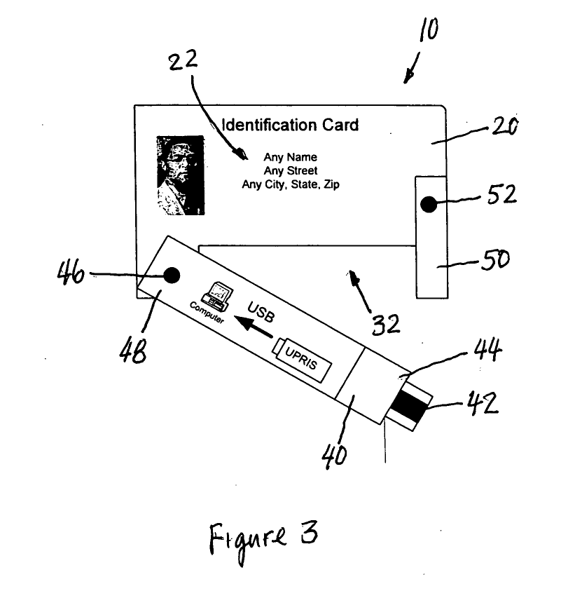

As shown in FIG. 3, the USB flash drive 40 preferably has a male type-A USB connector 42 at a first end 44 of the USB flash drive 40. The connector 42 can engage a corresponding female USB connector (not shown) on a computer or any other device for data transfer.

The USB flash drive 40 may have a housing, although preferably it does not have a housing to reduce the dimensions of the USB flash drive 40.

Preferably, the USB flash drive 40 is attached to the card portion 20 to form the identification card 10. The USB flash drive 40 may be attached to any suitable location, on the card portion 20. For example, the USB flash drive 40 may be attached to an edge section of the card portion 20. On the other hand, any portion of the USB flash drive 40 may be attached to the card portion 20. For example, one or both ends of the USB flash drive 40 may be attached to the card portion 20, or the middle section of the USB flash drive 40 may be attached to the card portion 20. The USB flash drive 40 may be attached to the card portion 20 in any suitable manner. For example, the USB flash drive 40 may be glued, welded, riveted or screwed to the card portion 20. Alternatively, the USB flash drive 40 may form a unitary or integral part with the card portion 20.

In the illustrated embodiment, the USB flash drive 40 is pivotably riveted to the card portion 20 by a first rivet 46 at its second end 48 (FIGS. 1 and 3). This way, as shown in FIG. 3, the USB flash drive 40 can be pivoted away from the card portion 20 about the first rivet 46 to an open position. At the open position, it is much easier for the user to plug the USB male connector 42 into a corresponding USB female connector (not shown), because the card portion 20 offers less interference. After use, the USB flash drive 40 can be pivoted back to the closed position shown in FIG. 1 so that the identification card 10 can be easily stored and carried.

As shown in FIGS. 1-3, the identification card 10 may also include a cap 50 for the USB connector 42 of the USB flash drive 40. The cap 50 may have a slot to accommodate and protect the USB connector 42 of the USB flash drive 40. Also the cap 50 helps keep the USB flash drive 40 in the closed position. The cap 50 may be pivotably attached to the card portion 20 by a second rivet 52. To remove the cap from the USB flash drive 40, the cap 50 may be pivoted counterclockwise in FIG. 1 about the second rivet 52. To place the cap 50 on the USB flash drive 40, the cap 50 may be pivoted clockwise in FIG. 1 about the second rivet 52. Alternatively, the cap 50 may not pivot, and the USB connector 42 of the USB flash drive 40 can be placed in or removed from the cap 50 through a side opening (now shown).

Preferably, as shown in FIGS. 1-3, the card portion 20 has a cutaway 32 to accommodate the USB flash drive 40. In this way, the identification card 10 can retain a generally rectangular configuration.

1. An identification card comprising:
a card portion; and
a USB flash drive that is pivotably attached to the card portion.
